(19) United States
(12) Patent Application Publication
(10) Pub. No.: US 2019/0093782 A1
(43) Pub. Date: Mar. 28, 2019

(54) Pressure-Limiting Valve

(71) Applicant: Robert Bosch GmbH, Stuttgart (DE)

(72) Inventors: Holger Muehlhoff, Hoesbach (DE); Robert Schloeder, Gemuenden (DE); Dieter Born, Lohr (DE); Wasilij Schieder, Gemuenden (DE)

(21) Appl. No.: 15/535,780

(22) PCT Filed: Dec. 16, 2015
(86) PCT No.: PCT/EP2015/080020

§ 371 Date: Jun. 14, 2017

(30) Foreign Application Priority Data
Dec. 16, 2014 (DE) 102014225983.5

(51) Int. Cl. F16K 27/02; F16K 15/02; B23P 15/00; C21D 5/00; C21D 1/06

(52) U.S. Cl. CPC F16K 27/0209; F16K 15/028; C21D 1/06; C21D 5/00; B23P 15/002

(57) ABSTRACT

A pressure-limiting valve includes a housing and a pressure adjustment device provided therein. The pressure-limiting valve further includes a valve seat arranged in the housing and configured to be closed by a spring-loaded closing element of the pressure adjustment device. The housing is composed of cast iron having spherical graphite. The housing is surface-hardened at least in a region of the valve seat.

The invention relates to a pressure-limiting valve as per the preamble of patent claim 1.

In the case of known pressure-limiting valves, the housing is normally composed of steel, in particular of a solid steel block, wherein receptacles for pressure adjustment devices and pressure medium ducts have to be drilled in the housing. In some cases, for manufacturing reasons, it is also necessary for bores that have been formed to be closed off again, because they were required only for the production of the bores required for operation, but which would be detrimental during operation. This normal approach is cumbersome in terms of manufacturing and is thus expensive.

DE 10 2004 040 359 B4 has disclosed a general pressure-regulating fitting, the housing of which is produced by means of a casting process. During the production of the housing, required pressure medium ducts and receptacles can duly be produced concomitantly in an inexpensive manner, but the fitting disclosed in said document has a very large space requirement not least owing to a valve seat that is accessible from both sides. Said accessibility to the valve seat is however necessary for the work hardening method disclosed in said document for hardening of the valve seat, firstly in order to perform the work hardening using suitable tools but also in order to permit cutting finish machining using suitable tools such as for example milling cutters, such as is required after the work hardening in order to ensure the dimensional accuracy of the valve seat.

By contrast to this, it is the object of the invention to realize a pressure-limiting valve which can be produced in an inexpensive manner.

Said object is achieved by means of a pressure-limiting valve having the features of patent claim 1.

Advantageous refinements of the pressure-limiting valve according to the invention are described in the further subclaims.

A pressure-limiting valve according to the present invention comprises a housing and a valve seat which is formed in the housing and which can be closed by means of a spring-loaded closing element of the pressure-limiting valve. According to the invention, the housing is composed of cast iron with spheroidal graphite, in particular GGG or GJS—referred to as “nodular graphite iron”, wherein the housing is surface-hardened at least in a region of the valve seat.

Surface hardening comprises hardening methods such as for example induction hardening, laser hardening or flame hardening.

An advantage of the pressure-limiting valve according to the invention is that pressure medium ducts and other receptacles are formed during the casting of the housing and do not need to be produced by cutting machining after the completion of the housing, wherein surface hardening is an inexpensive hardening method because, owing to the good dimensional accuracy, cutting finish machining is normally not necessary, or is at least kept within narrow limits, and thus tool usage is reduced.

The housing is advantageously produced using a precision or investment casting method such as for example a lost wax method, in particular using a wax model encased in flame-resistant mold material. In this way, increased dimensional accuracy can be achieved which reduces tool usage for cutting finish machining. It is furthermore for example possible to use sand cores, produced from sand and phenol resin, and so-called printed cores, produced from plastic by rapid prototyping and/or rapid manufacturing methods.

It is advantageous if, in the housing, there is provided at least one receptacle, formed in particular in the manner of a blind hole, in which the pressure adjustment device is at least partially arranged, wherein the receptacle comprises the valve seat. In this way, a compact and space-saving design of the pressure-limiting valve can be realized. Furthermore, in this way, simplified production of the housing and thus of the pressure-limiting valve can be achieved.

The receptacle is preferably of approximately rotationally symmetrical form. In this way, it is in particular possible for rotating tools to be introduced into the receptacle, for example for any reworking of the valve seat that may be required before or after the surface hardening. Furthermore, it is thus possible for a thread to be formed into the receptacle, by means of which thread the pressure adjustment device can be fastened in the receptacle. It is furthermore preferable for the receptacle to be formed as a recess in the housing.

The valve seat is advantageously arranged approximately in a closing direction of the closing element proceeding from the pressure adjustment device. In this way, it is furthermore possible to achieve compact and space-saving design of the pressure-limiting valve.

The abovementioned surface hardening has not only the advantages mentioned above but also the advantage that, owing to the thus reduced tool usage for the finish machining, a considerably more compact and space-saving arrangement in particular of the pressure adjustment device and of the receptacle in the housing can be selected. In particular, in this way, the valve seat can be arranged so as to be accessible only from a single side, in particular via the receptacle, in particular substantially in the closing direction of the closing element, for the surface hardening, in particular by means of a tool, and/or for finish machining by means of a tool.

The closing element advantageously has a closing cone, a guide piston being arranged on the closing element in the closing direction proceeding from said closing cone. The closing cone, in particular a contact surface of the closing cone, is in contact with the valve seat when the closing element is in a closed state. The closing element and the guide piston are advantageously of single-part form.

It is advantageous for a spring plate of the pressure adjustment device to be arranged on, in particular adjacent to, the closing element counter to the closing direction proceeding from the closing cone.

The closing element and the spring plate may be in single-part or multi-part form.

A transition of the receptacle between the spring plate and the valve seat is advantageously at least partially of conical form. In particular, the transition from a region of the spring plate in a closed position of the closing element to the valve seat is of at least partially conically tapering form. By means of the design of the transition according to the invention, weakening of the housing is reduced. In particular, in the case of the design of the transition according to the invention, in relation to a transition with constant diameter, more housing material remains between the receptacle and a fastening recess provided in the housing adjacent to the receptacle, by means of which fastening recess the pressure-limiting valve can be fastened to a plate or between two plates. It is advantageous for multiple fastening recesses to be provided in the housing, which fastening recesses are preferably formed as through-holes for the fastening of the pressure-limiting valve in a simple manner, for example by means of through-bolts. It is furthermore preferable for the spring plate to be of conically tapering form in a closing direction at a section which projects beyond a spring of the pressure adjustment device.

The diameter of the receptacle may decrease in the closing direction, in particular in stepped and/or continuous fashion.

It is hereby pointed out that the design according to the invention of the receptacle, in particular of the transition, is regarded as an independent invention; the applicant reserves the right to possibly direct a dedicated patent application to this at a later point in time.

The pressure-limiting valve is preferably formed in the manner of an intermediate plate, wherein the housing advantageously has two abutment surfaces which are plane-parallel with respect to one another. By means of the surface hardening according to the invention, it is possible, as described above, to achieve the compact arrangement of the individual regions in the pressure-limiting valve according to the present invention, and thus to realize the space-saving design thereof, which are expedient prerequisites for a design which is constructed in the manner of an intermediate plate.

The pressure-limiting valve is preferably directly controlled, which further promotes a compact and space-saving design of the pressure-limiting valve according to the invention.

It is advantageous for two receptacles which are arranged substantially mirror-symmetrically with respect to one another to be provided in the housing. Here, as described above, a pressure adjustment device is arranged at least partially in each of the receptacles. Furthermore, as described above, the valve seat is provided in each of the receptacles. With this arrangement, it is possible in a space-saving manner for a respective pressure in two mutually independent pressure medium circuits to be limited to the value set at the respective pressure adjustment device. As an alternative to this, the two pressure-limiting valves may be connected fluidically in series.

Several exemplary embodiments of a pressure-limiting valve according to the invention are illustrated in the drawings. The invention will now be discussed in more detail on the basis of the figures of said drawings.

In the figures:

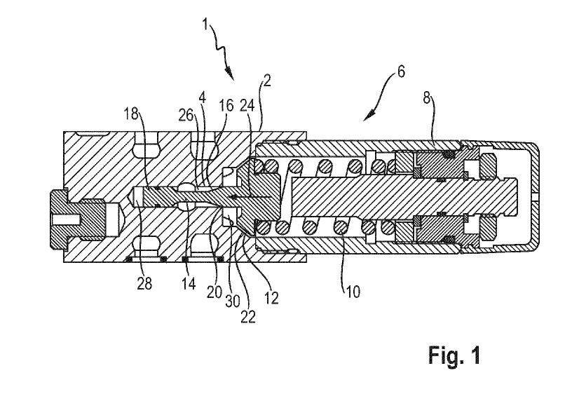

FIG. 1 shows, in a longitudinal section, a front view of a pressure-limiting valve according to the invention as per a first exemplary embodiment, and

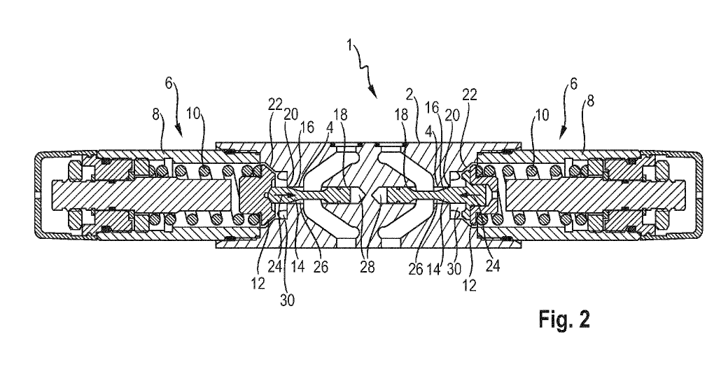

FIG. 2 shows, in a longitudinal section, a front view of a pressure-limiting valve according to the invention as per a second exemplary embodiment.

The first exemplary embodiment of a pressure-limiting valve 1 according to the invention as illustrated in FIG. 1 comprises a housing 2 in which there is provided a receptacle 4 for a pressure adjustment device 6 which is provided in the housing 2.

The pressure adjustment device 6 comprises a reduction piece 8, a spring 10 that can be preloaded therein, and a spring plate 12. Here, the spring plate 12 is formed as one part with a spring-loaded closing element 14, which has a closing cone 16 and a guide piston 18 in a closing direction 24 proceeding from the spring plate 12.

The reduction piece 8 is screwed into the receptacle 4, wherein an internal thread is provided in the receptacle 4 and a corresponding external thread is provided on the reduction piece 8.

The receptacle 4 comprises a valve seat 20 and a transition 22 from a region of the spring plate 12 in a closed position of the closing element 14 to the valve seat 20. In the region of the valve seat 20, the housing 2 is surface-hardened in order to permanently ensure a sealing function between valve seat 20 and closing cone 16 and thus increase a service life of the pressure-limiting valve.

The closing element 14 is preloaded in its closing direction 24 against the valve seat 20 by means of the spring 10.

The transition 22 is formed so as to taper conically in the closing direction 24. The spring plate 12 is, at its section which projects beyond the spring 10, formed so as to taper conically in the closing direction 24.

Proceeding from the position of the spring plate 12 in its closed position in the receptacle 4 for the pressure adjustment device 6, the transition 22 to the valve seat is arranged in the closing direction 24 of the closing element 14, and further in the closing direction 24, the guide piston 18 is arranged in the receptacle 4. In its closed position, the closing cone 16 is in contact, by means of a contact surface, with the valve seat 20, and seals off a high-pressure side with respect to a low-pressure side.

Between the guide piston 18 and the closing cone 16, there is arranged a rod section of the closing element 14 with a reduced diameter in relation to the guide piston 18 and/or the contact surface of the closing cone 16. With the receptacle 4, the rod section delimits a ring-shaped chamber 26, and the guide piston 18 delimits a piston chamber 28, wherein a ring-shaped gap is provided between guide piston 18 and receptacle 4. The ring-shaped gap serves for pressure medium equalization between the ring-shaped chamber 26 and the piston chamber 28 as soon as the closing element moves in the receptacle. The size of the ring-shaped gap determines a degree of damping with which the movement of the closing element 14 in the receptacle 4 is dampened, because the interaction between spring 10 and closing element 14, in particular with the spring plate 12, constitutes in physical terms a spring/mass system which could otherwise oscillate in undampened fashion.

A high pressure prevails in the ring-shaped chamber 26 and in the piston chamber 28, and a low pressure prevails in a pressure medium chamber 30 which is arranged adjacent to the valve seat 22 counter to the closing direction 24. If the high pressure in interaction with the closing element 14 exceeds a value which corresponds to the equivalent of the spring 10, the closing element 14 is lifted with its closing cone 16 from the valve seat 20 counter to the closing direction 24, and pressure medium can flow out via the pressure medium chamber 30 into a pressure medium sink (not illustrated). The high pressure is thus limited to the value that corresponds to the equivalent of the spring 10, wherein the value is settable or adjustable.

In the second exemplary embodiment of the pressure-limiting valve 1 according to the invention shown in FIG. 2, two pressure adjustment devices 6 with a respectively associated receptacle 4 are arranged in substantially mirror-symmetrical fashion in the housing 2.

The receptacles 4 illustrated in the second exemplary embodiment correspond to the receptacle 4 of the first exemplary embodiment as shown in FIG. 1 and described above. The pressure adjustment devices 6 used in the second exemplary embodiment substantially correspond to the pressure adjustment device 6 of the first exemplary embodiment as shown in FIG. 1 and described above, wherein two different variants of closing elements 14 and spring plates 12 of multi-part design are illustrated. These different variants will be described below.

In the variant illustrated on the left-hand side in the drawing, the spring plate 12 and the closing element 14 are of multi-part form, such that a spherical end section of the closing element 14 comes into contact with a correspondingly formed counterpart surface of the spring plate 12. In this way, it is advantageously possible for alignment errors between the spring 10 or the spring plate 12 and the closing element 14 to be compensated.

In the variant illustrated on the right-hand side in the drawing, the spring plate 12 and the closing element 14 are of multi-part form such that a cylindrical end section of the closing element 14 comes into contact with a correspondingly formed counterpart surface of the spring plate 12. Here, the spring plate 12 is of approximately hat-shaped form. In this way, the closing element 14 can be guided with its cylindrical end section in the spring plate 12 in an effective manner.

The invention discloses a pressure-limiting valve having a cast housing, the valve seat of which is surface-hardened. In this way, the advantage of inexpensive production of the housing with internal pressure medium ducts receptacles, in particular for a pressure adjustment device, combined with the advantage of a long-term sealing function, is ensured by means of a method which can be carried out in a reliable manner and which, owing to its good dimensional accuracy, requires only reduced finish machining, if any. Owing to this prerequisite, a more compact and thus space-saving arrangement of functional regions accommodated in the housing, in particular of a pressure adjustment device and of an associated receptacle, is made possible. In particular, a valve seat can be arranged so as to be accessible only from a single side, in particular substantially in a closing direction of the closing element, for the surface hardening and/or for finish machining by means of a tool.

### LIST OF REFERENCE DESIGNATIONS

1 Pressure-limiting valve

### 2 Housing

### 4 Receptacle

6 Pressure adjustment device
8 Reduction piece

### 10 Spring

12 Spring plate
14 Closing element
16 Closing cone
18 Guide piston
20 Valve seat

### 22 Transition

24 Closing direction
26 Ring-shaped chamber
28 Piston chamber
30 Pressure medium chamber

1. A pressure-limiting valve comprising:
a housing;
a spring-loaded closing element; and
a valve seat formed in said housing and configured to be closed by the spring-loaded closing element
wherein the housing is composed of cast iron with spheroidal graphite, and
wherein the housing is surface-hardened at least in a region of the valve seat.

2. The pressure-limiting valve as claimed in claim 1, further comprising:
a receptacle formed in the housing,
wherein a pressure adjustment device is at least partially arranged in the receptacle, and
wherein the receptacle includes the valve seat.

3. The pressure-limiting valve as claimed in claim 2, wherein the valve seat is arranged approximately in a closing direction of the closing element proceeding from the pressure adjustment device.

4. The pressure-limiting valve as claimed in claim 2, wherein the valve seat is accessible from a single side through the receptacle for the surface-hardening and/or for finish machining by a tool.

5. The pressure-limiting valve as claimed in claim 3, wherein:
the closing element has a closing cone, and
a guide piston is arranged on the closing element in the closing direction proceeding from said closing cone.

6. The pressure-limiting valve as claimed in claim 5, wherein further comprising:
a spring plate of the pressure adjustment device arranged on the closing element counter to the closing direction proceeding from the closing cone.

7. The pressure-limiting valve as claimed in claim 6, wherein the closing element and the spring plate are in single-part or multi-part form.

8. The pressure-limiting valve as claimed in claim 6, wherein a transition of the receptacle between the spring plate and the valve seat is at least partially of conical form.

9. The pressure-limiting valve as claimed in claim 1, wherein the valve is constructed in the manner of an intermediate plate.

10. The pressure-limiting valve as claimed in claim 1, wherein the valve is directly controlled.

11. The pressure-limiting valve as claimed in claim 2, wherein the receptacle is a first receptacle and the pressure-limiting valve further comprises:
a second receptacle,
wherein the first receptacle and the second receptacle are provided substantially mirror-symmetrically with respect to one another in the housing.

12. A method of forming a pressure-limiting valve including a housing, a spring-loaded closing element, and a valve seat, the method comprising:
forming the housing from cast iron with spheroidal graphite;
forming the valve seat in the housing; and
surface-hardening the housing at least in a region of the valve seat,
wherein the valve seat is configured to be closed by the spring-loaded closing element.

13. The method of claim 12, further comprising:
accessing the valve seat from a single side of the housing through the receptacle with a tool for the surface-hardening.
